(19) United States
(12) Patent Application Publication
(10) Pub. No.: US 2006/0204237 A1
(43) Pub. Date: Sep. 14, 2006

(54) Electronic device and button module thereof

(75) Inventor: Yung-Chin Cho, Taipei County (TW)

Correspondence Address: BIRCH STEWART KOLASCH & BIRCH, PO BOX 747, FALLS CHURCH, VA, 22040-0747, US

(73) Assignee: BENQ CORPORATION

(21) Appl. No.: 11/370,828

(22) Filed: Mar. 9, 2006

(30) Foreign Application Priority Data
Mar. 10, 2005 (TW) 94107267

(51) Int. Cl. G03B 17/00

(52) U.S. Cl. 396/299

(57) ABSTRACT

A button module for an electronic device. A spring element comprising a convex portion engages a main body, and is supported by a holder. The main body is pushed to move the spring element and the holder with the convex portion interfering with the rib.

### BACKGROUND

The invention relates to a button module, and in particular to a button module with a spring element providing a switch feeling.

Typically, in digital cameras, a function button is used to push a rod which switches between a normal mode or a macro mode of a charge coupled device or a lens. The function button comprises an electronic slide switch or an elastic arm to provide a switch feeling. The function button is fixed by a bolt or a plastic tab which is heated to melt. FIG. 12 depicts a button structure with an elastic arm providing the switch feeling. An elastic arm 300 is fixed to a button 200 by a bolt 250. The button 200 can be pushed or pulled on a camera housing 500 in the direction of the arrows. A protrusion 320 is disposed on the tip of the elastic arm 300, and a metal sheet 400 is under the elastic arm 300. Grooves 420 corresponding to the protrusion 320 are defined on the metal sheet 400. When pushed or pulled, the switch feeling of the button 200 is provided by the protrusion 320 moving in and out of the grooves 420.

Employing a bolt or a tab can cause complicated assembly, and the electronic slide switch can be limited to the scope of electronic elements.

### SUMMARY

A button module for an electronic device comprising a rib according to an embodiment of the invention comprises: a main body; a spring element engaged with the main body and comprising a convex portion; and a holder supporting the spring element, wherein the main body is pushed to move the spring element and the holder with the convex portion interfering with the rib.

The spring element further comprises a tab engaged with a hole of the main body so as to join the spring element and the main body. The main body is T-shaped, and the spring element further comprises a first through hole and the holder comprises a second through hole, wherein the main body is inserted into the first and second through holes, thereby joining the spring element and the holder.

### BRIEF DESCRIPTION OF THE DRAWINGS

The invention can be more fully understood by reading the subsequent detailed description and examples with references made to the accompanying drawings, wherein:

FIG. 1 is a perspective view of an embodiment of a digital camera according to the invention;

FIG. 2 is an exploded perspective view of an embodiment of a digital camera according to the invention;

FIG. 3 is an exploded perspective view of an embodiment of a digital camera according to the invention;

FIG. 4 is a perspective view showing a metal spring element and a holder of an embodiment according to the invention;

FIG. 5 is a perspective view showing a metal spring element and a holder assembled to a front housing of an embodiment according to the invention;

FIG. 6 is another perspective view showing a metal spring element and a holder assembled to a front housing of an embodiment according to the invention;

FIG. 7 is a perspective view showing a button module assembled to a front housing of an embodiment according to the invention;

FIG. 8 is another perspective view showing a button module assembled to a front housing of an embodiment according to the invention;

FIG. 9 is a front view of FIG. 8;

FIG. 10 is a perspective view showing the spring element providing the switch feeling of an embodiment according to the invention;

FIG. 11 is a front view of FIG. 10; and

FIG. 12 is a schematic view of a conventional button structure.

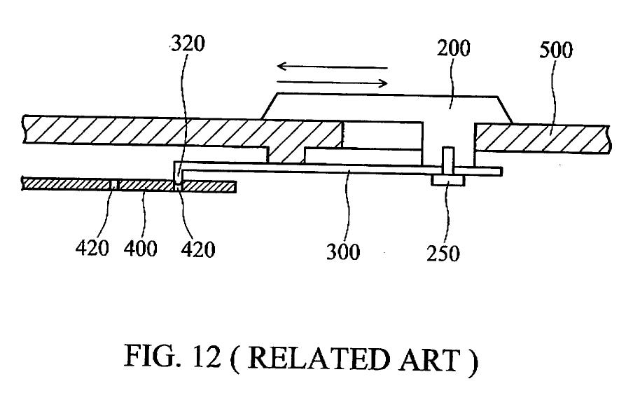

### DETAILED DESCRIPTION

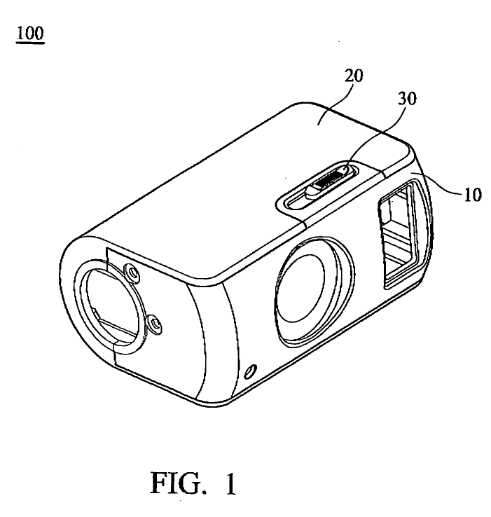

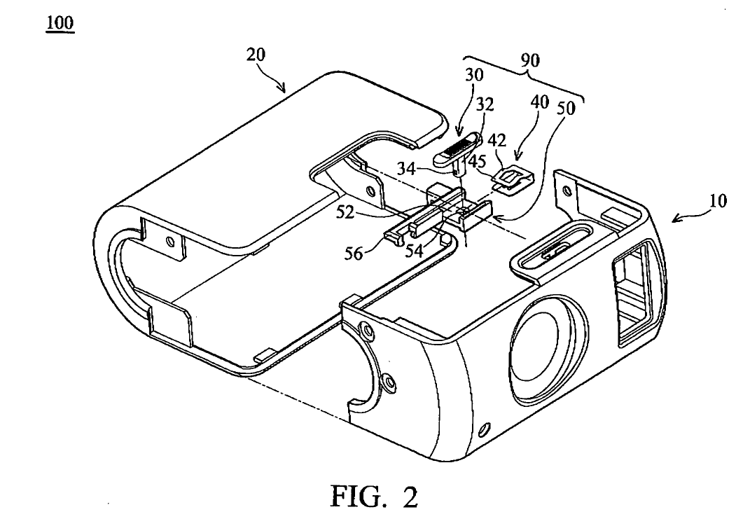

Referring to FIGS. 1, 2 and 3, a digital camera 100 comprises a front housing 10, a rear housing 20 and a button module 90 comprising a main body 30, a spring element 40 and a holder 50. The spring element 40 can be made of metal. The main body 30 is T-shaped and comprises a foot 32 on which a hole 34 is defined. The spring element 40 is C-shaped, and the upper half of the spring element 40 acts as an elastic arm 45 on which a convex portion 42 is defined. The holder 50 comprises a flat portion 52 for the spring element 40 clamping thereto and an arm 56 pushing a push rod (not shown). FIG. 1 depicts the digital camera 100 with only the main body 30 revealed outside the front and rear housings 10 and 20.

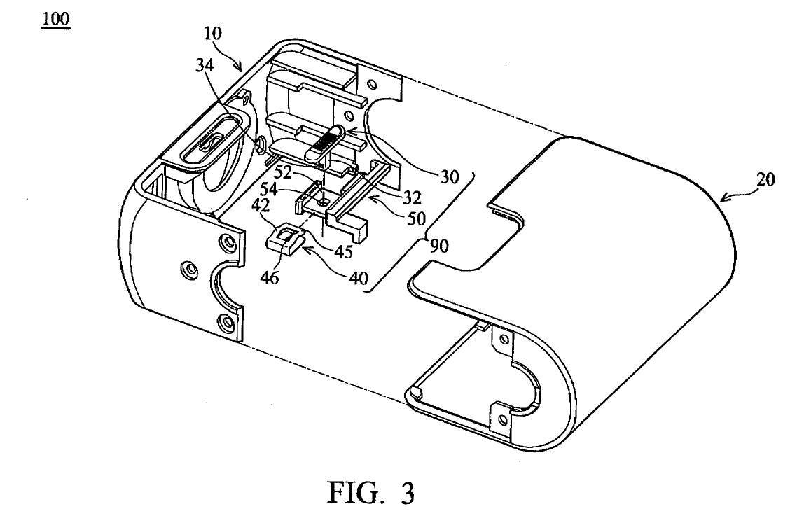

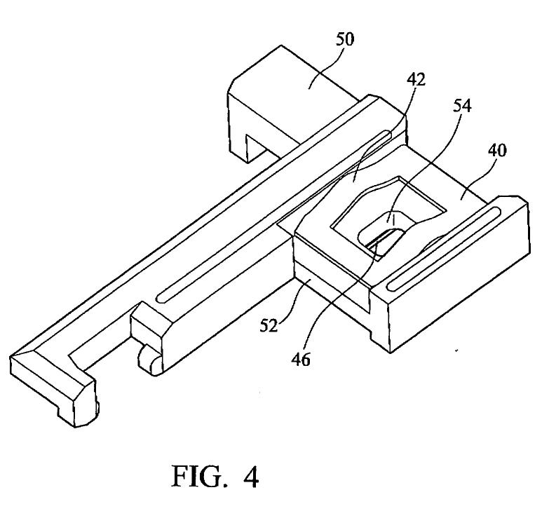

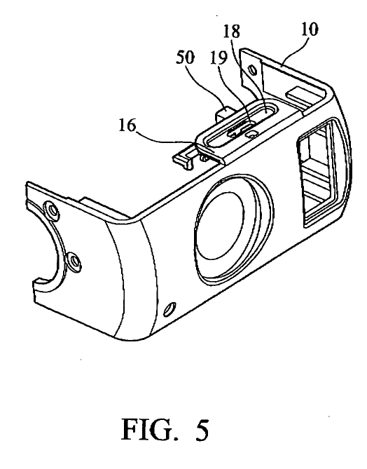

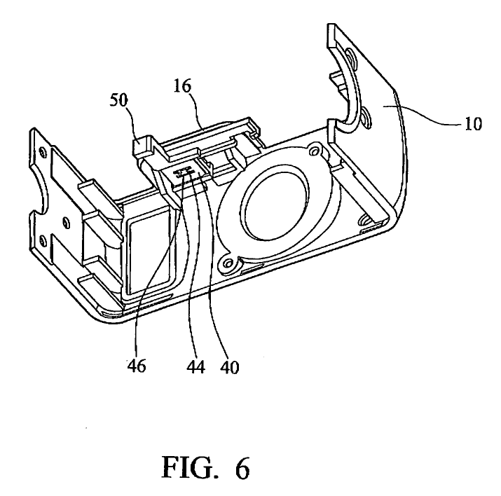

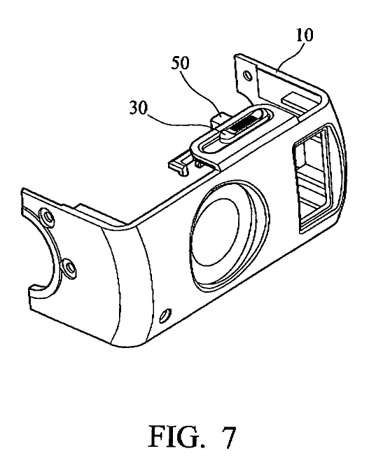

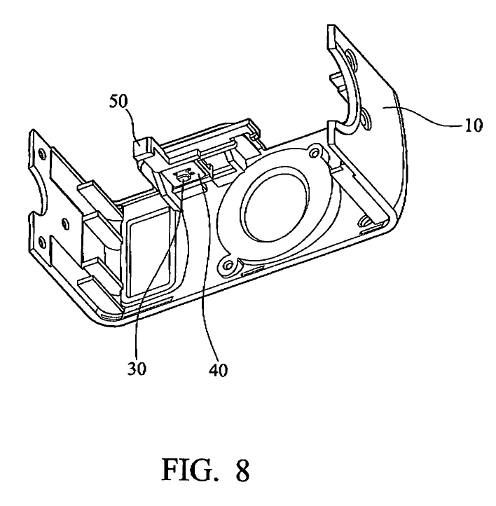

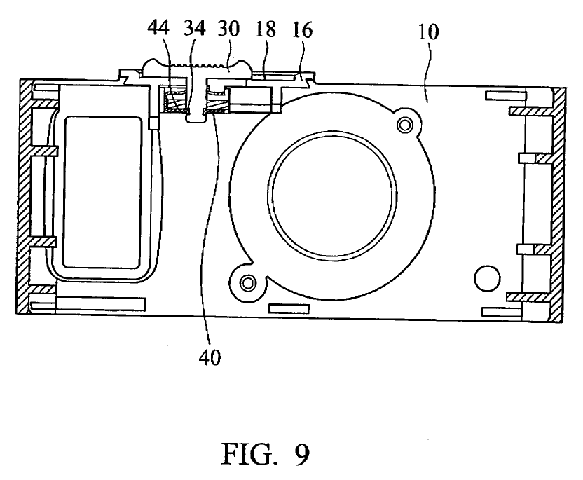

The spring element 40 clamps the flat portion 52 of the holder 50, as shown in FIG. 4. The spring element 40 comprises a first through hole 46 (referring to FIG. 3), and the flat portion 52 of the holder 50 comprises a second through hole 54. When the spring element 40 clamps the flat portion 52, the first through hole 46 aligns with the second through hole 54. The assembled spring element 40 and holder 50 are placed to an inner wall of an extension portion 16 of the front housing 10. Referring to FIGS. 5 and 6, the extension portion 16 has a depression 18 on which a hole 19 is defined. T-shaped main body 30 is accommodated in the depression 18 with the foot 32 through the hole 19, the first through hole 46 and the second through hole 54 as shown in FIGS. 7 and 8. The spring element 40 has two tabs 44 slightly curved downward and disposed on the edge of the first through hole 46. When the T-shaped main body 30 is inserted into first through hole 46, the tab 44 is inserted into the hole 34 as shown in FIG. 9, whereby the main body 30 engages the spring element 40 and the holder 50, and the button module 90 is joined with the front housing 10. the main body 30 is pushed or pulled to move the holder 50 as well as move the arm 56 to push or pull the push rod (not shown).

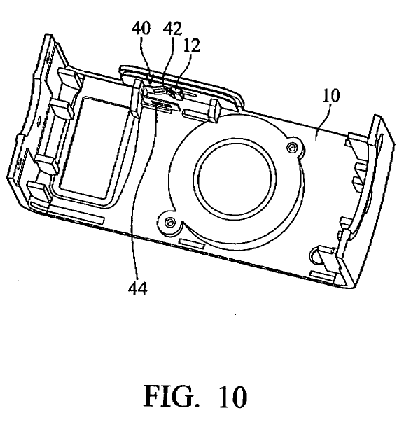

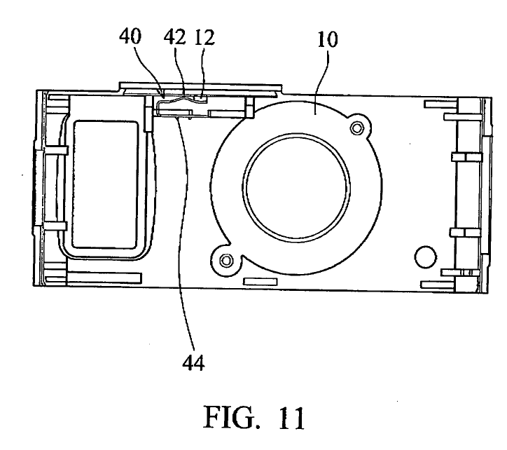

FIGS. 10 and 11 depicts the spring element 40 disposed on the front housing 10. For the sake of clarity, the main body 30 and the holder 50 are omitted. The spring element 40 comprises a convex portion 42, and a rib 12 is disposed on the inner wall of the extension portion 16. When the spring element 40 is moved by the main body 30, the convex portion 44 interferes with the rib 12 to provide the switch feeling.

The spring element 40 of the button module 90 provides the switch feeling and joins the main body 30 and the holder 50, thereby avoiding complicated assembly.

Although a digital camera is described in this embodiment, the button structure of the invention is not limited to a digital camera. The button structure of the invention can applied to various electronic devices according to requirements.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A button module for an electronic device comprising a rib, comprising:
a main body;
a spring element engaged with the main body and comprising a convex portion; and
a holder supporting the spring element, wherein the main body is pushed to move the spring element and the holder with the convex portion interfering with the rib.

2. The button module as claimed in claim 1, wherein the spring element comprises an arm on which the convex portion is disposed.

3. The button module as claimed in claim 1, wherein the spring element further comprises a tab engaged with the main body to joint the spring element and the main body.

4. The button module as claimed in claim 3, wherein the main body comprises a hole for engaging the tab thereto.

5. The button module as claimed in claim 1, wherein the main body is T-shaped, and the spring element further comprises a first through hole and the holder comprises a second through hole, wherein the main body is inserted into the first and second through holes, thereby joining it with the spring element and the holder.

6. The button module as claimed in claim 1, wherein the spring element is made of metal.

7. An electronic device, comprising:
a cover with a rib;
a main body;
a spring element engaged with the main body and comprising a convex portion; and
a holder supporting the spring element, wherein the main body is pushed to move the spring element and the holder with the convex portion interfering with the rib.

8. The electronic device as claimed in claim 7, wherein the spring element comprises an arm on which the convex portion is disposed.

9. The electronic device as claimed in claim 7, wherein the spring element further comprises a tab engaged with the main body to joint the spring element and the main body.

10. The electronic device as claimed in claim 9, wherein the main body comprises a hole for engaging the tab thereto.

11. The electronic device as claimed in claim 7, wherein the main body is T-shaped, and the spring element further comprises a first through hole and the holder comprises a second through hole, wherein the main body is inserted into the first and second through holes, thereby joining it with the spring element and the holder.

12. The electronic device as claimed in claim 11, wherein the cover is disposed between the main body and the spring element.

13. The electronic device as claimed in claim 7, wherein the cover is disposed between the main body and the spring element.

14. The electronic device as claimed in claim 7, wherein the spring element is made of metal.
